(19) United States
(12) Patent Application Publication
(10) Pub. No.: US 2012/0226498 A1
(43) Pub. Date: Sep. 6, 2012

(54) MOTION-BASED VOICE ACTIVITY DETECTION

(75) Inventor: Remi Ken-Sho Kwan, Montreal (CA)

(73) Assignee: MICROSOFT CORPORATION, Redmond, WA (US)

(21) Appl. No.: 13/039,184

(22) Filed: Mar. 2, 2011

(51) Int. Cl. G10L 15/00

(52) U.S. Cl. 704/233; 704/E15.001

(57) ABSTRACT

Motion-based voice activity detection may be provided. A data stream may be received and a determination may be made whether at least one non-audio element associated with the data stream indicates that the data stream comprises speech. In response to determining that the at least one non-audio element associated with the data stream indicates that the data stream comprises speech, a speech to text conversion may be performed on at least one audio element associated with the data stream.

### BACKGROUND

Motion-based voice activity detection is a process for improving the robustness of voice activity detection in noisy environments by incorporating non-acoustic information. In some situations, environmental noise has an adverse effect on speech detection system performance. Conventional speech coding, speech enhancement, and speech recognition systems often make use of a voice activity detection component that decides whether a sample of audio contains speech or non-speech. For example, non-speech or silence detection may be used to achieve silence compression and coding efficiency in order to reduce the bandwidth used in transmission of speech data. In conventional systems, voice activity detection relies on features or observations in the acoustic signal. As background noise increases, noise masks the speech signal making detection more difficult.

### SUMMARY

Motion-based voice activity detection may be provided. This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

Motion-based voice activity detection may be provided. A data stream may be received and a determination may be made whether at least one non-audio element associated with the data stream indicates that the data stream comprises speech. In response to determining that the at least one non-audio element associated with the data stream indicates that the data stream comprises speech, a speech to text conversion may be performed on at least one audio element associated with the data stream.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of an operating environment;

FIG. 2 is a flow chart of a method for providing voice activity detection; and

FIG. 3 is a block diagram of a system including a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Motion-based voice activity detection may be provided. Consistent with embodiments of the present invention, better detection of non-speech can also help provide better estimates of background noise that can improve speech enhancement, as well as reducing the potential for insertion errors (false speech) in a speech recognition system.

Voice activity detection (VAD) may be used in speech processing, speech communication and speech recognition systems to make a speech/non-speech decision and provide information on when a user is speaking. This may allow a system to know when it should be focused on the user and processing speech. For example, if a sample of audio does not contain speech, processing that audio in a speech recognition system may lead to spurious recognition errors.

The task of VAD may be viewed as one of binary classification where a decision rule may decide whether the system should be in one of two states: speech or non-speech, based on various inputs. In conventional systems, these inputs are computed based solely on characteristics or features of the audio stream, such as zero-crossing or energy level. Consistent with embodiments of the invention, other inputs, such as motion-based streams may be incorporated with the audio stream as inputs to the decision rule.

One such motion-based stream may comprise the output of an accelerometer. An accelerometer comprises a sensor that measures the acceleration of a device. The accelerometer may provide acceleration measures in three axes: x, y, z. For example, a measurement of 0,0,1 may indicate a device (phone) at rest. A device in motion may produce a continuous stream of such measurements. Regular samples of this data stream may be measured to provide information on the relative motion of the device (moving up, moving down, etc.). By combining these samples, features on the motion-based stream may be computed. Similarly, another motion-based stream may comprise the output of a proximity sensor that may provide measurements on whether the sensor is occluded by being held near a face or other object.

Once features are computed on the input streams, they may be fed into a decision rule. Consistent with embodiments of the invention, the decision rule may be operative to change state between speech and non-speech according to a threshold on the raw acceleration values. For example, acceleration values in the z-axis below a certain threshold may signify that a user has lifted the phone towards their mouth to speak, while the inverse may signal the receiver is brought away in order to view results. In this way, the motion may be used as a switch to change speech/non-speech states. Further consistent with embodiments of the invention, a flick and/or other user-defined or learned motion may signal speech on and another motion may signal speech off. The threshold at which to switch states may be tuned manually and/or the decision rule may be learned from supervised examples of motion streams annotated with speech/non-speech using standard machine learning techniques.

Further consistent with embodiments of the invention, the decision to change state may be based on additional inputs and features such as audio features and/or inputs from other components and/or applications associated with the device. The decision rule may be triggered, for example, when acceleration values in the z-axis are below a certain threshold and the average audio energy for a moving window is above a certain threshold. Other features used may include motion samples, audio samples, average audio energy, the current state of the device (e.g., whether the device is currently in a speech detection mode or not), length of time in the current state, background audio energy, user interface inputs, status of device features (e.g., whether a speakerphone feature is active), and/or background motion. Again, the thresholds may be determined manually and/or the decision rule may be learned from examples using standard machine learning techniques. The decision rule may be learned without the requirement for supervised examples by bootstrapping from an audio-only VAD system. In learning mode, the system may simultaneously record audio samples and motion samples. An initial decision of the speech/non-speech boundaries in the stream may be determined using traditional audio-based VAD. Samples, collected with the audio based decision may then be used as examples to learn the threshold or decision rule for the motion-based system.

Speech-to-text conversion (i.e., speech recognition) may comprise converting a spoken phrase into a text phrase that may be processed by a computing system. Acoustic modeling and/or language modeling may be used in modern statistic-based speech recognition algorithms. Hidden Markov models (HMMs) are widely used in many conventional systems. HMMs may comprise statistical models that may output a sequence of symbols or quantities. HMMs may be used in speech recognition because a speech signal may be viewed as a piecewise stationary signal or a short-time stationary signal. In a short-time (e.g., 10 milliseconds), speech may be approximated as a stationary process. Speech may thus be thought of as a Markov model for many stochastic purposes.

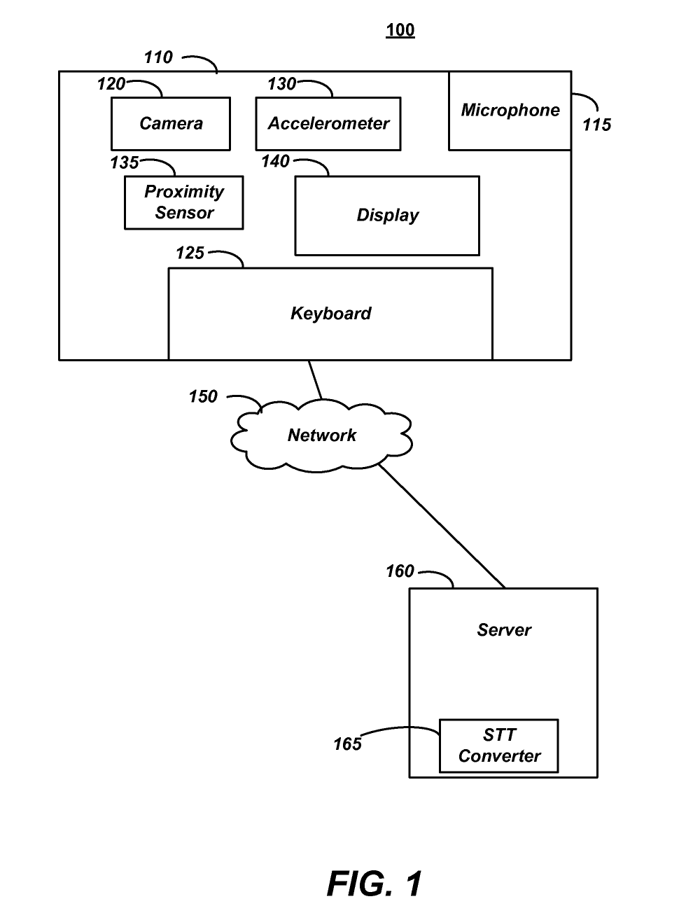

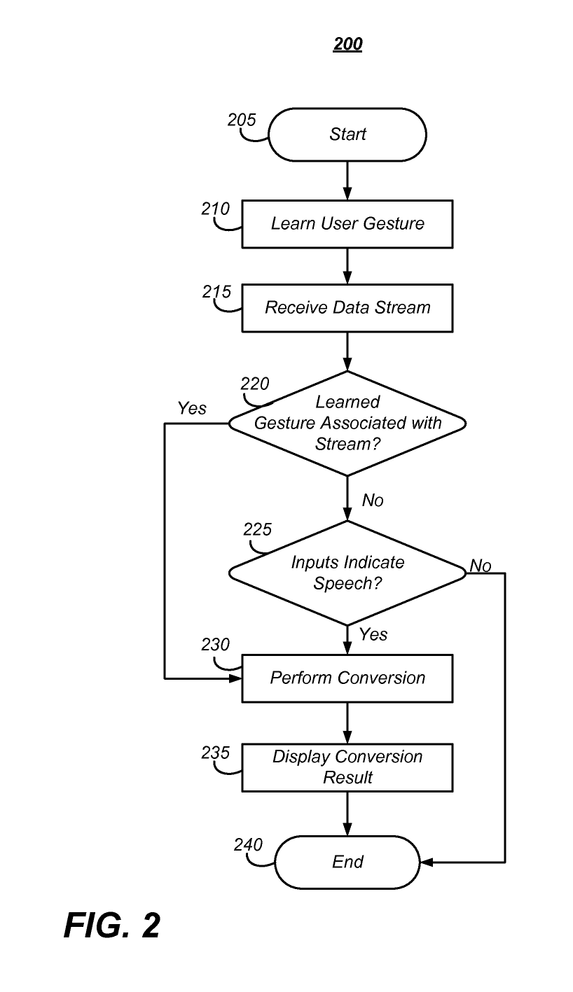

FIG. 1 is a block diagram of an operating environment 100 for providing voice activity detection. Operating environment 100 may comprise a user device 110 comprising a plurality of components such as a microphone 115, a camera 120, a keyboard 125, an accelerometer 130, a proximity sensor 135, and/or a display 140. User device 110 may be operative to communicate over a network 150 with a server 160. Network 150 may comprise a public and/or private IP network, such as a corporate LAN and/or the Internet. Network 150 may also comprise a wireless network, such as a cellular network. Server 160 may be operative to send and/or receive data from user device 110 and may comprise a speech-to-text converter 165. Consistent with embodiments of the invention some and/or all of the stages of a method 200 described below with respect to FIG. 2 may be performed by user device 110 and/or server 160 (e.g., user device 110 may comprise a speech-to-text conversion component of its own).

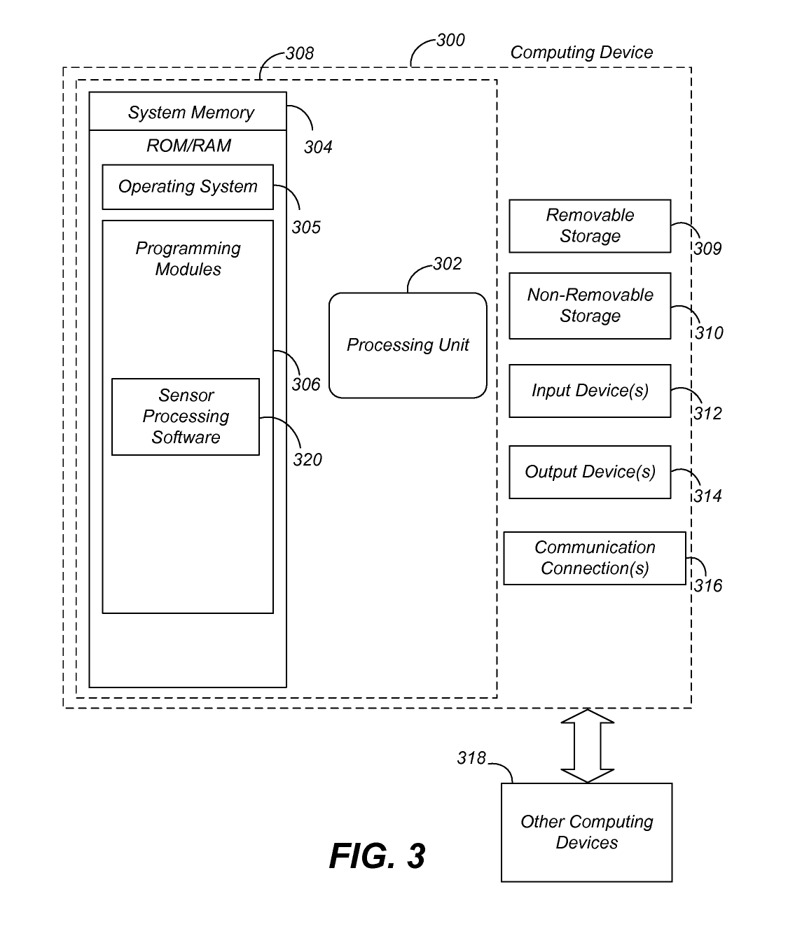

FIG. 2 is a flow chart setting forth the general stages involved in a method 200 consistent with an embodiment of the invention for providing voice activity detection. Method 200 may be implemented using a computing device 300 as described in more detail below with respect to FIG. 3. Ways to implement the stages of method 200 will be described in greater detail below. Method 200 may begin at starting block 205 and proceed to stage 210 where computing device 300 may learn at least one gesture associated with the user indicating that the data stream comprises speech. For example, user device 110 may operate in a learning mode during which all audio streams received from microphone 115 may be scanned for speech elements. Audio streams that are determined to comprise speech elements may be associated with inputs from other sensors, such as proximity sensor 135 and/or accelerometer 130. User device 110 may identify a correlation with accelerometer 130 detecting an upwards movement of user device 110 and/or an object (e.g., a user's head) being in close proximity to user device 110 via proximity sensor 135 when an audio stream does comprise speech. Once user device 110 is no longer operating in a learning mode, user device 110 may associate these inputs with the presence of speech elements in an audio stream.

From stage 210, method 200 may advance to stage 215 where computing device 300 may receive a data stream from a user. For example, microphone 115 may record an audio stream associated with the user's current environment.

From stage 215, method 200 may advance to stage 220 where computing device 300 may determine whether the learned gesture has been detected in association with the data stream. For example, the audio stream may be associated with a substantially contemporaneous input from accelerometer 130 indicating that user device 110 is moving. The movement may comprise a learned gesture of moving upwards indicating that the audio stream is more likely to contain audio data or moving downwards indicating that the audio stream is less likely to contain audio data.

In response to determining that the learned gesture has not been detected, method 200 may advance to stage 225 where computing device 300 may determine whether a plurality of non-audio inputs associated with the data stream indicate that the data stream comprises speech. For example, the plurality of inputs may comprise a sensor reading (e.g., from accelerometer 130), a user input (e.g., typing on keyboard 125), a device status (e.g., operating in speakerphone mode), and an application status (e.g., playing a game and/or activating a voice memo application). Such inputs may be associated with probabilities and/or weighting that user device 110 may use to decide whether the audio stream is likely to contain speech.

In response to determining that the plurality of inputs associated with the data stream indicates that the data stream comprises speech, or if the learned gesture has been detected in association with the data stream, method 200 may advance to stage 230 where computing device 300 may perform a speech to text conversion on at least one audio element associated with the data stream. For example, user device 110 may perform a Hidden Markov Model conversion on the audio stream and/or transmit the audio stream over network 150 to STT converter 165 of server 160 for conversion.

From stage 210, method 200 may advance to stage 220 display the converted text to the user. For example, user device 110 may display the results of the speech-to-text conversion on display 140 for further manipulation (e.g., submitting the text to a search engine). Method 200 may then end at stage 240.

An embodiment consistent with the invention may comprise a system for providing voice activity detection. The system may comprise a memory storage and a processing unit coupled to the memory storage. The processing unit may be operative to receive a data stream, determine whether at least one non-audio element associated with the data stream indicates that the data stream comprises speech, and in response to determining that the at least one non-audio element associated with the data stream indicates that the data stream comprises speech, perform a speech to text conversion on at least one audio element associated with the data stream. The at least one non-audio element may comprise an input from at least one sensor, such as an accelerometer, an application, a camera, a keyboard, and/or a proximity sensor. The converted text may be displayed to the user. If the at least one non-audio element associated with the data stream does not indicate that the data stream comprises speech, the data stream may be discarded without further processing.

An accelerometer input may comprise a movement vector associated with a directional movement of user device 110. Determining that the at least one non-audio element associated with the data stream indicates that the data stream comprises speech may comprise determining that the movement vector comprises an upwards movement while determining that the at least one non-audio element associated with the data stream does not indicate that the data stream comprises speech may comprise determining that the movement vector comprises a downwards movement. The movement vector may comprise a user-defined (e.g., specifically identified by the user), a system defined, and/or a learned gesture.

Another embodiment consistent with the invention may comprise a system for providing voice activity detection. The system may comprise a memory storage and a processing unit coupled to the memory storage. The processing unit may be operative to receive a data stream from a user, determine whether a plurality of inputs associated with the data stream indicate that the data stream comprises speech, and, if so, perform a speech to text conversion on at least one audio element associated with the data stream and display the converted text to the user. The plurality of inputs may comprise, for example, a sensor reading, a user input, a device status, and an application status. Each input may be associated with a priority weighting and/or a rule operative to modify the priority weighting associated with at least one second input. For example, a rule may reduce a priority weighting associated with an accelerometer reading if a speakerphone status is active. Such priority weighting may be overridden in response to receiving a request from a user, such as a learned gesture associated with indicating that the data stream comprises speech.

Yet another embodiment consistent with the invention may comprise a system for providing voice activity detection. The system may comprise a memory storage and a processing unit coupled to the memory storage. The processing unit may be operative to learn at least one gesture associated with the user indicating that the data stream comprises speech, receive a data stream from a user, and determine whether the at least one learned gesture has been detected in association with the data stream. In response to determining that the at least one learned gesture has not been detected, the processing unit may be operative to determine whether a plurality of non-audio inputs associated with the data stream indicate that the data stream comprises speech. The plurality of inputs may comprise, for example, a sensor reading, a user input, a device status, and an application status. In response to determining that the plurality of inputs associated with the data stream indicates that the data stream comprises speech, or if the at least one learned gesture has been detected in association with the data stream, the processing unit may be operative to perform a speech to text conversion on at least one audio element associated with the data stream and display the converted text to the user.

FIG. 3 is a block diagram of a system including computing device 300. Consistent with an embodiment of the invention, the aforementioned memory storage and processing unit may be implemented in a computing device, such as computing device 300 of FIG. 3. Any suitable combination of hardware, software, or firmware may be used to implement the memory storage and processing unit. For example, the memory storage and processing unit may be implemented with computing device 300 or any of other computing devices 318, in combination with computing device 300. The aforementioned system, device, and processors are examples and other systems, devices, and processors may comprise the aforementioned memory storage and processing unit, consistent with embodiments of the invention. Furthermore, computing device 300 may comprise operating environment 100 as described above. System 100 may operate in other environments and is not limited to computing device 300.

With reference to FIG. 3, a system consistent with an embodiment of the invention may include a computing device, such as computing device 300. In a basic configuration, computing device 300 may include at least one processing unit 302 and a system memory 304. Depending on the configuration and type of computing device, system memory 304 may comprise, but is not limited to, volatile (e.g. random access memory (RAM)), non-volatile (e.g. read-only memory (ROM)), flash memory, or any combination. System memory 304 may include operating system 305, one or more programming modules 306, and may include a sensor processing software application 320. Operating system 305, for example, may be suitable for controlling computing device 300's operation. In one embodiment, programming modules 306 may include. Furthermore, embodiments of the invention may be practiced in conjunction with a graphics library, other operating systems, or any other application program and is not limited to any particular application or system. This basic configuration is illustrated in FIG. 3 by those components within a dashed line 308.

Computing device 300 may have additional features or functionality. For example, computing device 300 may also include additional data storage devices (removable and/or non-removable) such as, for example, magnetic disks, optical disks, or tape. Such additional storage is illustrated in FIG. 3 by a removable storage 309 and a non-removable storage 310. Computing device 300 may also contain a communication connection 316 that may allow device 300 to communicate with other computing devices 318, such as over a network in a distributed computing environment, for example, an intranet or the Internet. Communication connection 316 is one example of communication media.

The term computer readable media as used herein may include computer storage media. Computer storage media may include volatile and nonvolatile, removable and non-removable media implemented in any method or technology for storage of information, such as computer readable instructions, data structures, program modules, or other data. System memory 304, removable storage 309, and non-removable storage 310 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 300. Any such computer storage media may be part of device 300. Computing device 300 may also have input device(s) 312 such as a keyboard, a mouse, a pen, a sound input device, a touch input device, etc. Output device(s) 314 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

As stated above, a number of program modules and data files may be stored in system memory 304, including operating system 305. While executing on processing unit 302, programming modules 306 (e.g. sensor processing software application 320) may perform processes including, for example, one or more of method 200's stages as described above. The aforementioned process is an example, and processing unit 302 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for providing voice activity detection, the method comprising:
receiving a data stream;
determining whether at least one non-audio element associated with the data stream indicates that the data stream comprises speech; and
in response to determining that the at least one non-audio element associated with the data stream indicates that the data stream comprises speech, processing at least one audio element associated with the data stream as speech.

2. The method of claim 1, wherein the at least one non-audio element comprises an input from at least one sensor.

3. The method of claim 2, wherein the at least one sensor comprises an accelerometer.

4. The method of claim 3, wherein the input from the accelerometer comprises a movement vector.

5. The method of claim 4, wherein determining that the at least one non-audio element associated with the data stream indicates that the data stream comprises speech comprises determining that the movement vector comprises an upwards movement.

6. The method of claim 4, wherein determining that the at least one non-audio element associated with the data stream does not indicate that the data stream comprises speech comprises determining that the movement vector comprises a downwards movement.

7. The method of claim 4, wherein the movement vector is associated with a user-defined gesture.

8. The method of claim 1, wherein processing the at least one audio element comprises at least one of the following: performing a speech to text conversion and recording the at least one audio element.

9. The method of claim 1 further comprising, in response to determining that the at least one non-audio element associated with the data stream does not indicate that the data stream comprises speech, discarding the data stream.

10. The method of claim 1, wherein the at least one sensor is associated with at least one of the following: a keyboard, a proximity sensor, a camera, and an application.

11. A computer-readable medium which stores a set of instructions which when executed performs a method for providing voice activity detection, the method executed by the set of instructions comprising:
receiving a data stream from a user;
determining whether a plurality of inputs associated with the data stream indicate that the data stream comprises speech;
in response to determining that the plurality of inputs associated with the data stream indicates that the data stream comprises speech, performing a speech to text conversion on at least one audio element associated with the data stream; and
displaying the converted text to the user.

12. The computer-readable medium of claim 11, wherein the plurality of inputs comprise at least one of the following: a sensor reading, a user input, a device status, and an application status.

13. The computer-readable medium of claim 12, wherein each of the plurality of inputs is associated with a priority weighting.

14. The computer-readable medium of claim 13, wherein at least one first input of the plurality of inputs is associated with a rule operative to modify the priority weighting associated with at least one second input.

15. The computer-readable medium of claim 14, wherein the at least one first input comprises a speakerphone status and the at least one second input comprises an accelerometer reading.

16. The computer-readable medium of claim 15, further comprising modifying the priority weighting associated with the accelerometer reading if the speakerphone status is active.

17. The computer-readable medium of claim 13, further comprising overriding the priority weighting associated with at least one of the plurality of inputs in response to receiving a request from a user.

18. The computer-readable medium of claim 11, wherein the request from the user comprises a learned gesture associated with indicating that the data stream comprises speech.

19. The computer-readable medium of claim 11, further comprising sending the data stream to a server for speech to text conversion in response to determining that the plurality of inputs associated with the data stream indicates that the data stream comprises speech.

20. A system for providing voice activity detection, the system comprising:
a memory storage; and
a processing unit coupled to the memory storage, wherein the processing unit is operative to:
learn at least one gesture associated with the user indicating that the data stream comprises speech;
receive a data stream from a user;
determine whether the at least one learned gesture has been detected in association with the data stream;
in response to determining that the at least one learned gesture has not been detected, determine whether a plurality of non-audio inputs associated with the data stream indicate that the data stream comprises speech, wherein the plurality of inputs comprise at least one of the following: a sensor reading, a user input, a device status, and an application status;
in response to determining that the plurality of inputs associated with the data stream indicates that the data stream comprises speech, perform a speech to text conversion on at least one audio element associated with the data stream; and
display the converted text to the user.
